(19) United States
(12) Patent Application Publication
(10) Pub. No.: US 2024/0273274 A1
(43) Pub. Date: Aug. 15, 2024

(54) Method for establishing transistor statistical model based on artificial neural network system

(71) Applicant: Peking University Shenzhen Graduate School, Shenzhen (CN)

(72) Inventors: Lining ZHANG, Shenzhen (CN); Wu DAI, Shenzhen (CN); Yu LI, Shenzhen (CN); Runsheng WANG, Shenzhen (CN); Ru HUANG, Shenzhen (CN)

(73) Assignee: Peking University Shenzhen Graduate School, Shenzhen (CN)

(21) Appl. No.: 18/427,865

(22) Filed: Jan. 31, 2024

(30) Foreign Application Priority Data
Feb. 15, 2023 (CN) 202310157186.0

(51) Int. Cl. G06F 30/373; G06F 119/06

(52) U.S. Cl. CPC G06F 30/373; G06F 2119/06

(57) ABSTRACT

A method of establishing a transistor statistical model based on an artificial neural network system comprising receiving a first data set and generating a nominal model of a baseline transistor by the artificial neural network system based on the first data set; screening neurons in the artificial neural network system based on the first data set and the nominal model to obtain final variational neurons; obtaining distribution of weights of the final variational neurons and distribution of threshold voltages based on variation of the nominal model with respect to weights of the final variational neurons, variation of the nominal model with respect to the threshold voltages, distribution of the drain-source current and distribution of the gate-source voltage in the first data set; and establishing the transistor statistical model based on the nominal model, the distribution of weights of the final variational neurons and the distribution of the threshold voltages.

### TECHNICAL FIELD

The present disclosure relates to the field of electronic circuit model, in particular, to a method of establishing a transistor statistical model based on an artificial neural network system.

### BACKGROUND

With continuous development of More than Moore's Law technology, limited by a series of second-order effects brought about by scaling down in actual production, people have begun to introduce new materials or propose new structures in devices, and more and more emerging devices have been developed. The physical mechanism of emerging devices is more complicated, which correspondingly brings great challenges to the modeling work of these devices. At the same time, physics-based models have long development cycles and slow simulation times. It is not beneficial for design technology co-optimization.

For general purpose devices, any of the process parameters will affect the device characteristics. During fabrication of the devices, process parameters such as channel length, and oxide layer thickness have a relatively large impact on the performance of emerging devices, e.g., off-state current, on-state current, sub-threshold slope, and threshold voltage. The device model requires consideration of fluctuation of device process parameters and its impact on device performance, so as to ensure the reliability of mass production of devices, especially emerging devices, while ensuring technology advancement.

### SUMMARY

For solving the technical problems existing in the prior art, the present disclosure provides a method of establishing a transistor statistical model based on an artificial neural network system, comprising receiving a first data set, and generating a nominal model of a baseline transistor by the artificial neural network system based on the first data set, the first data set including multiple sets of gate-source voltage data, drain-source voltage data, and drain-source current data of multiple transistors of a same type, wherein the multiple transistors of a same type include the baseline transistor and a plurality of variational transistors, wherein the baseline transistor is determined according to a median or average value of the drain-source current data of the multiple transistors of the same type under the same bias condition, and the rest of the multiple transistors are variational transistors; screening neurons in the artificial neural network system based on the first data set and the nominal model to obtain final variational neurons; obtaining distribution of weights of the final variational neurons and distribution of threshold voltages based on variation of the nominal model with respect to weights of the final variational neurons, variation of the nominal model with respect to threshold voltage, distribution of the drain-source current and distribution of the gate-source voltage of the multiple transistors of the same type in the first data set; and establishing the transistor statistical model based on the nominal model, the distribution of weights of the final variational neurons and the distribution of the threshold voltages.

Specifically, said screening neurons in the artificial neural network system based on the first data set and the nominal model to obtain final variational neurons comprises, changing weights of at least part of the neurons in the artificial neural network system in the nominal model, until difference between an intermediate output curve after the change of the weights and current-voltage characteristic curve of a variational transistor is less than a first threshold, and taking the changed weights as adjusted weights of the at least part of the neurons with regards to the variational transistor, wherein the intermediate output curve refers to the output curve obtained after change of the weights; for each of the variational transistors, calculating an absolute value of relative change between the adjusted weights and initial weights for each of the at least part of the neurons in the nominal model; calculating an average value of the absolute values for each of the at least part of the neurons in the artificial neural network system, and screening out preliminary variational neurons based on the average value; and screening out the final variational neurons based on a range of output variation of the preliminary variational neurons.

Specifically, the first threshold is less than or equal to 5% of the drain-source current of the variational transistor involved in comparison.

Specifically, preliminary variational neurons with output variation range greater than or equal to 0.1 are taken as the final variational neurons.

Specifically, the variation of the nominal model with respect to weights of the final variational neurons includes, a partial derivative of the drain-source current in the nominal model with respect to the weights of the final variational neurons and a partial derivative of the gate-source voltage in the nominal model with respect to the weights of the final variational neurons.

Specifically, the variation of the nominal model with respect to the threshold voltage includes, a partial derivative of the drain-source current in the nominal model with respect to the threshold voltage and a partial derivative of the gate-source voltage in the nominal model with respect to the threshold voltage.

Specifically, the distribution of the drain-source current and the distribution of the gate-source voltage of the multiple transistors of the same type in the first data set include a standard deviation of the drain-source current and a standard deviation of the gate-source voltage.

Specifically, the distribution of weights of the final variational neurons in the statistical model includes a standard deviation of weights of the final variational neurons, and the distribution of the threshold voltages in the statistical model includes a standard deviation of the threshold voltages.

The present application also provides a method of applying a transistor statistical model based on an artificial neural network system, comprising receiving a second data set including multiple sets of gate-source voltage data, drain-source voltage data of multiple transistors of a same type, the multiple transistors including a baseline transistor and a plurality of variational transistors, wherein the baseline transistor is determined according to a median or average value of drain-source current data of the multiple transistors of the same type under the same bias condition, and the rest are variational transistors, and the second data set also includes multiple sets of data of drain-source current data of the baseline transistors and part of the variational transistors; establishing the transistor statistical model by obtaining distribution of threshold voltages in the statistical model and distribution of weights of final variational neurons based on the multiple sets of gate-source voltage data, drain-source voltage data and drain-source current data of the baseline transistor and part of variational transistors in the second data set, wherein the final variational neurons are from the artificial neural network system; selecting a plurality of threshold voltages from the distribution of the threshold voltages, and performing calculating to obtain corresponding adjusted gate-source voltages accordingly to the selected threshold voltages; selecting a plurality of weights for the final variational neurons from the distribution of weights of the final variational neurons; and generating drain-source currents data of the multiple transistors of the same type that are not included in the second date set, based on the plurality of adjusted gate-source voltages and the plurality of selected weights for the final variational neuron.

Specifically, the threshold voltages are randomly selected based on Gaussian distribution from the distribution of the threshold voltages, and the corresponding weights are randomly selected based on Gaussian distribution from the distribution of weights of the final variational neurons.

Specifically, establishing the statistical model by obtaining distribution of threshold voltages in the statistical model and distribution of weights of final variational neurons based on the multiple sets of gate-source voltage data, drain-source voltage data and drain-source current data of the baseline transistor and part of the variational transistors in the second data set comprises, generating a nominal model of the baseline transistor by the artificial neutral network system based on the multiple sets of data of gate-source voltage data, drain-source voltage data, and drain-source current data of the baseline transistor and part of the variational transistors in the second data set; screening neurons in the artificial neural network system to select final variational neurons based on the nominal model and the multiple sets of gate-source voltage data, drain-source voltage data and drain-source current data of the baseline transistor and part of the variational transistors in the second data set; obtaining distribution of weights of the final variational neurons and distribution of threshold voltages in the statistical model based on variation of the nominal model with respect to weights of the final variational neurons, variation of the nominal model with respect to the threshold voltages, distribution of the drain-source current and distribution of the gate-source voltage of the baseline transistor and part of the variational transistors in the second data set; and establishing the statistical model based on the nominal model, the distribution of weights of the final variational neurons and the distribution of the threshold voltages.

Specifically, said screening neurons in the artificial neural network system to select final variational neurons based on the multiple sets of gate-source voltage data, drain-source voltage data and drain-source current data of the baseline transistors and part of the variational transistors in the second data set comprises, changing weights of at least part of the neurons in the artificial neural network system in the nominal model, until difference between an intermediate output curve after the change of weights and a current-voltage characteristic curve of a variational transistor is less than a first threshold, taking the changed weights as adjusted weights of the at least part of the neurons with regards to the variational transistor, wherein the intermediate output curve refers to the output curve after change of the weights; for each of the variational transistors, calculating absolute values of relative change between the adjusted weights and initial weights for each of the at least part of the neurons in the nominal model; calculating an average value of the absolute values for each of the at least part of the neurons in the artificial neural network system, and screening out preliminary variational neurons according to the average values; and screening out the final variational neurons based on neuron output variation range of the preliminary variational neurons.

Specifically, the first threshold is less than or equal to 5% of the drain-source current of the variational transistor involved in comparison.

Specifically, the preliminary variational neuron with the neuron output variation range of greater than or equal to 0.1 is used as the final variational neuron.

Specifically, the variation of the nominal model with respect to weights of the final variational neurons includes, a partial derivative of the drain-source current in the nominal model with respect to the weights of the final variational neurons and a partial derivative of the gate-source voltage in the nominal model with respect to the weights of the final variational neurons.

Specifically, the variation of the nominal model with respect to the threshold voltage includes, a partial derivative of the drain-source current in the nominal model with respect to the threshold voltage and a partial derivative of the drain-source current in the nominal model with respect to the threshold voltage.

Specifically, the distribution of the drain-source current and the distribution of the gate-source voltage of the baseline transistor and part of variational transistors in the second data set include, a standard deviation of the drain-source current and a standard deviation of the gate-source voltage.

Specifically, the distribution of weights of the final variational neurons in the statistical model includes, standard deviation of weights of the final variational neurons, and the distribution of the threshold voltages in the statistical model includes, standard deviation of the threshold voltages.

The present application also provides a computer-readable storage medium, comprising a memory storing a computer program, the computer program being executed to complete the method of establishing a transistor statistical model based on an artificial neural network system according to any one of the above.

The present application also provides computer-readable storage medium, comprising a memory storing a computer program, the computer program being executed to complete the method of applying a transistor statistical model of an artificial neural network system according to any one of above.

The solution of the present disclosure could, on the basis of accelerating compact model construction of transistors, ensure low complexity and high precision of the model, and meanwhile improve reliability of the transistor model by grasping performance changes caused by process fluctuations, significantly increasing simulation speed of generating transistor models.

### BRIEF DESCRIPTION OF THE DRAWINGS

Preferred embodiments of the present disclosure will be described in further detail below with reference to the accompanying drawings, wherein:

FIG. 1A is a flowchart of a method of establishing a transistor statistical model based on an artificial neural network system according to an embodiment of the present disclosure;

FIG. 1B is a flowchart of a method of screening neurons in an artificial neural network system to obtain final variational neurons according to an embodiment of the present disclosure;

FIG. 2 shows current-voltage characteristic curves of a plurality of transistors in first data set according to an embodiment of the present disclosure;

FIG. 3A to FIG. 3B show output curves of different preliminary variational neurons according to an embodiment of the present disclosure;

FIG. 4 is a schematic structural diagram of an artificial neural network system for establishing a transistor statistical model according to an embodiment of the present disclosure;

FIG. 5 is a flowchart of a method of applying a transistor statistical model based on an artificial neural network system according to an embodiment of the present disclosure;

FIG. 6A illustrates curves of the drain-source current as the output versus the gate-source voltage;

FIG. 6B is a probability distribution graph of I_{SAT} obtained by using a transistor statistical model of an artificial neural network system of the present disclosure;

FIG. 7 is a diagram showing comparison of time consumption when performing simulation using a transistor statistical model of an artificial neural network system of the present disclosure versus using a traditional physical model; and

FIG. 8 illustrates voltage transfer curves of an inverter circuit using a transistor statistical model according to an embodiment of the present disclosure.

### DETAILED DESCRIPTION

In order to make the purposes, technical solutions and advantages of the embodiments of the present disclosure clearer, the technical solutions in the embodiments of the present disclosure will be clearly and completely described below with reference to the drawings in the embodiments of the present disclosure. Obviously, the described embodiments are part of embodiments of the present disclosure, not all of them. Based on the embodiments in the present disclosure, all other embodiments obtained by those skilled in the art without making creative efforts fall into the scope of protection of the present disclosure.

In the following detailed description, please refer to the accompanying drawings in the specification, which, as a part of the present disclosure, illustrate specific embodiments of the present disclosure. In the drawings, similar reference signs describe substantially similar components in different views. Specific embodiments of the present disclosure are described in sufficient detail below, so that those skilled in the art can carry out the technical solutions of the present disclosure. It should be understood that other embodiments may also be utilized, and structural, logical or electrical modification can also be made to the embodiments of the present disclosure.

Techniques, methods and devices known to those skilled in the art may not be discussed in detail, but such techniques, methods and devices should be considered as part of the specification if appropriate. The connection between units in the drawings is only used for the convenience of description, which means that at least the units at both ends of the connection communicate with each other, and it is not intended to define that the units that are not connected cannot communicate with each other. In addition, the number of the lines between the two units is intended to indicate at least the number of signals involved in the communication between the two units or at least the output terminals provided, which is not used to define the communication between the two units can be achieved only with the signal as shown in the drawings.

Transistors may refer to transistors of any structure, such as field effect transistors (FETs) or bipolar junction transistors (BJTs). When the transistors are field effect transistors, according to different channel materials, they may be hydrogenated amorphous silicon, metal oxide, low temperature polysilicon, organic transistor, etc. According to the criteria whether the carriers are electrons or holes, transistors can be divided into N-type transistors and P-type transistors, and control pole refers to gate of a field effect transistor, the first pole can be a drain or source of the field effect transistor, and the corresponding second pole can be a source or drain of the field effect transistor. When the transistors are bipolar transistors, the control pole refers to base of the bipolar transistor, the first pole could be the collector or emitter of the bipolar transistor, and the corresponding second pole could be the emitter or the collector of the bipolar transistor. Transistors can be fabricated using amorphous silicon, polysilicon, oxide semiconductors, organic semiconductors, NMOS/PMOS processes, or CMOS processes. Of course, other types of transistors can also be used.

The existing modeling methods based on artificial neural network mainly relate to constructing compact models of electronic devices. The compact model refers to a model obtained by reasonably simplifying a physical model of electronic devices with reference to engineering experience or mathematical methods.

In recent years, artificial neural networks and related technologies have been continuously developed and widely used in various fields. In order to solve the above-mentioned problems of long modeling and simulation time and low model reliability of the electronic devices, modeling methods based on artificial neural network have emerged at the right moment. These methods are often specific to a single device. How to efficiently build models of a large number of devices is still a problem to be solved.

The present disclosure provides a method of establishing a transistor statistical model based on an artificial neural network system. The method, with consideration of the fluctuation of process parameters of multiple transistors and the output offset problem caused thereby, effectively improves reliability of the transistor model, contributes to greatly increasing the simulation speed of the transistor model, and thus demonstrates the advantage of establishing transistor models with artificial neural network in the large-scale Monte Carlo simulation process.

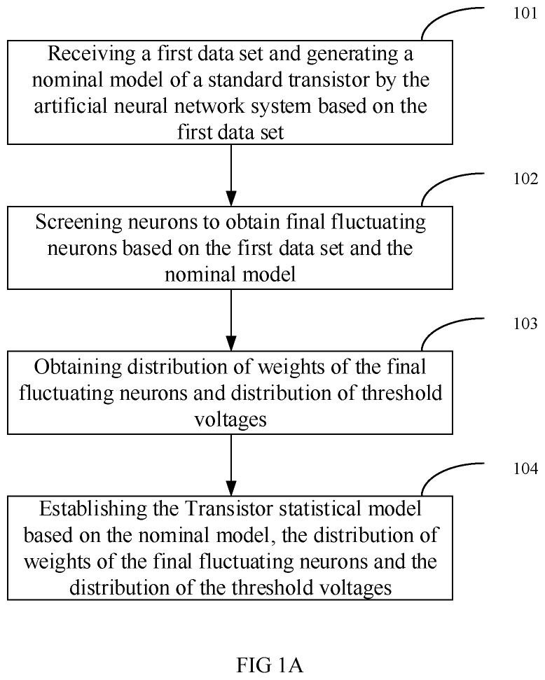

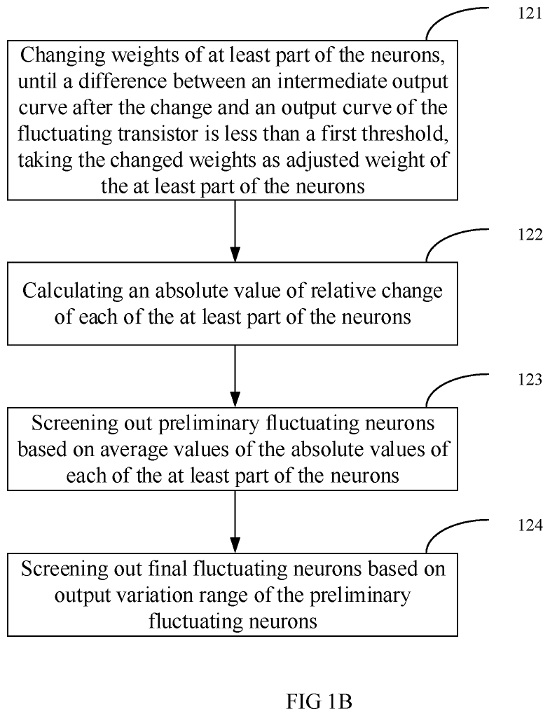

FIG. 1A is a flowchart of a method of establishing a transistor statistical model based on an artificial neural network system according to an embodiment of the present disclosure. According to an embodiment of the present disclosure, the data in the following datasets may be test data from GAA-FET, or test data obtained from other known sources.

As shown in FIG. 1A, the method may include the following operations:

According to an embodiment, at 101, receiving a first data set, and generating a nominal model of a baseline transistor by an artificial neural network system based on at least partial data in the first data set. The first data set may include multiple sets of gate-source voltage, drain-source voltage, and drain-source current data of multiple transistors of a same type, wherein the multiple transistors of the same type include the baseline transistor and multiple variational transistors.

According to an embodiment of the present disclosure, the baseline transistor may be determined according to a median value or an average value of drain-source current data of the plurality of transistors of the same type under the same bias condition in the first data set.

The same type of transistors described herein and in previous and following portions of this disclosure refers to transistors of the same category, having basically same physical structure, and manufactured with the same process. Due to reasons such as variations in the production process or others, slight differences such as size difference may exist between the variational transistors and the baseline transistor, resulting in certain differences in performance therebetween such as threshold voltage and output current. These differences are also known as fluctuations of the process parameters.

According to an embodiment, the nominal model refers to a model of the baseline transistor generated by training the artificial neural network based on at least partial data in the first data set.

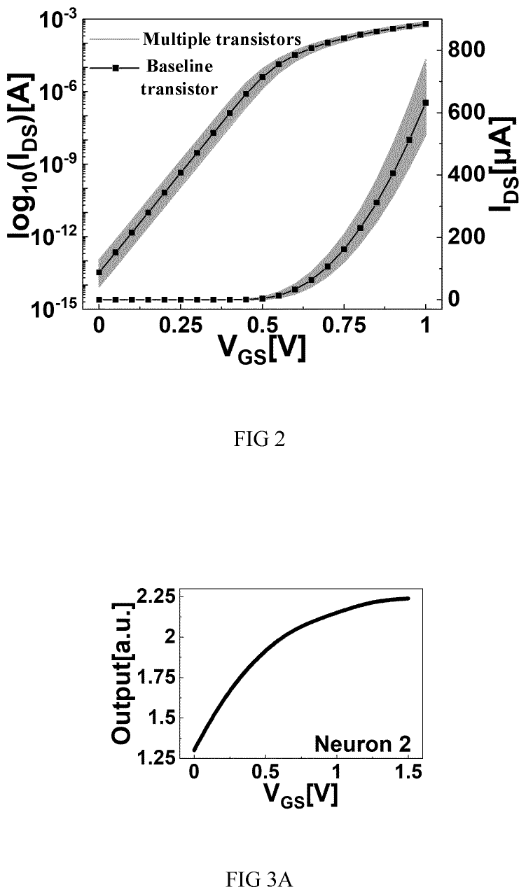

FIG. 2 is a current-voltage characteristic curve of a plurality of transistors in the first data set according to an embodiment of the present disclosure. The transistor mentioned here may be a three-terminal transistor having, for example, a source, a drain, and a gate. The black solid line in FIG. 2 refers to current-voltage output characteristic curve corresponding to the nominal model of the baseline transistor, and the gray solid lines (which look like an area due to the great number of lines) represent the current-voltage output characteristic curves corresponding to the data of multiple transistors of the same type as the baseline transistor. As shown in FIG. 2, due to the fluctuation of process parameters, the drain-source current output curves of multiple transistors in the first data set under the same bias condition is slightly different from the output curve of the nominal model, and it can be seen that, the current-voltage output characteristic curves are shifted with respect to the output characteristic curve of baseline transistor. The shift may include shift along the voltage axis, which refers to the difference between the gate-source voltages required by the multiple transistors to output the same drain-source current; it may also include the shift along the current axis, which refers to the difference between the drain-source currents generated at the same gate-source voltage of the multiple transistors.

According to different embodiments, the artificial neural network system suitable for the nominal model may include different structures, for example, which may include one or more artificial neural networks.

At 102: Based on the first data set and the nominal model, screening the neurons in the artificial neural network system to obtain final variational neurons.

According to one embodiment, part or all neurons in the artificial neural network system may be screened in the above screening operation.

Neurons may affect the performance of the transistor models during the simulation process, which can be used to reflect the fluctuation of process parameters of the corresponding transistors in actual production. Neurons may be screened to locate such affecting ones which are called final variational neurons hereinafter. According to one embodiment, for a system including only a single network, final variational neurons may be selected in the last layer of neurons before the output layer in the network. For a system including multiple networks, the final variational neurons can be screened among all neurons in all networks.

At 103: Based on the variation of the nominal model with respect to the weights of the final variational neurons, the variation of the nominal model with respect to the threshold voltage, the distribution of the drain-source current and the distribution of the gate-source voltage in the first data set, obtaining distribution of weights of the final variational neurons and distribution of the threshold voltage in the transistor statistical model.

According to different embodiments, the so-called variations here may refer to partial derivatives or variations reflected by other mathematical calculation methods. According to different embodiments, the so-called distribution here can be embodied as standard deviation, squared deviation, or other forms.

At 104: Establishing the transistor statistical model based on the nominal model, the distribution of weights of the final variational neurons, and the distribution of the threshold voltages.

FIG. 1B is a flowchart of a method of screening neurons in an artificial neural network system to locate final variational neurons according to an embodiment of the present disclosure.

At 121: Changing weight of at least part of the neurons in the artificial neural network system until the difference between an intermediate output curve after such change and the current-voltage characteristic curve of the variational transistor is less than a first threshold value, then taking this weight as an adjusted weight of the corresponding neuron.

According to one embodiment, the intermediate output curve refers to an output curve obtained by changing the weights of neurons in the system based on the data in the first data set and the nominal model. The current-voltage characteristic curve of the variational transistor refers to a curve formed based on current-voltage data corresponding to the variational transistors in the first data set.

The data of the plurality of variational transistors included in the first data set may include drain-source current values different from the nominal model's output under the same gate-source voltage and drain-source voltage. Changing the weights of the neurons so that the output of the nominal model is close to the current data of the variational transistors, the output offset caused by the fluctuations of the process parameters may be reflected by the weights of the neurons in the model and output changes. The adjusted weights of the neurons can be correspondingly regarded as influencing factors for establishing the statistical transistor model within the fluctuation range of the process parameters required for manufacture. The statistical transistor models obtained by analyzing the variation range and values of neuron weights can be considered as models that take into account the fluctuations of the process parameters.

According to one embodiment, the weight of each neuron may be adjusted by using gradient descent method.

According to an embodiment of the present disclosure, after the nominal model is established, each neuron in the artificial neural network system has its own weight obtained through prior training, also called the initial weight. When generating statistical models of multiple transistors, only the weights of selected neurons are changed while the weights of the other neurons keep the initial weights unchanged.

According to an embodiment of the present disclosure, the difference between the intermediate output curve of the nominal model after each change of the weights of the selected neurons and the current-voltage characteristic curve of the variational transistor, in the form of e.g., variance, can be used as the loss function, and it may be determined that whether to stop updating the weight of the selected neurons according to the relationship of the loss function and a first threshold.

According to an embodiment of the present disclosure, multiple iterations may be performed based on the loss function until the difference between the intermediate output curve and the output curve of the variational transistor is less than or equals to a first threshold. According to one embodiment, the first threshold may be, for example, a value of 5% of output of the variational transistor. According to an embodiment of the present disclosure, the maximum number of iterations may be, for example, 105. According to one embodiment, upon completion of each 104 iterations, the intermediate output curve is compared with the output curve of the variational transistor. If there is a current-voltage characteristic curve of a variational transistor that differs from the intermediate output curve by a level smaller than the first threshold, the calculation may be stopped. If the difference does not reach a level smaller than the first threshold after reaching the maximum number of iterations, the weight which renders the difference the smallest among all iterations will be taken as the weight of the selected neuron.

According to different embodiments, weights of one or more neurons may be changed at the same time. According to different embodiments, there may be more than one intermediate output curves satisfying the first threshold criteria, and the weight renders the smallest difference can be selected as the weight of the specific neuron.

At 122: With regards to each of the variational transistors, calculating the absolute value of relative change of the weight for each neuron.

According to an embodiment of the present disclosure, since the data in the first data set corresponds to n variational transistors (n can be an integer greater than 1), each neuron may have n updated weights accordingly, wherein for the k^{th} transistor the adjusted weight of the i^{th} neuron is Wᵢ^{(k)}, wherein k is an integer greater than or equal to 1 and less than or equal to n, and i is an integer greater than or equal to 1. Calculation maybe performed to obtain the absolute value of the relative change of the weight for each neuron. For example, the absolute value of the relative change ΔAᵢ^{(k)} of the weight of the i^{th} neuron before and after the change may be calculated. Specifically, the absolute value of the relative change of the weight ΔAᵢ^{(k)} satisfies the following relationship:

$$Δ {A}_{i}^{( k )} = \vert \frac{{W}_{i}^{( k )} - {W}_{i}^{( 0 )}}{{W}_{i}^{( 0 )}} \vert \qquad ( 1 )$$

wherein Wᵢ⁽⁰⁾ is the initial weight of the i^{th} neuron in the artificial neural network system.

At 123: Screening out preliminary variational neurons based on the average values of the absolute value of the relative change of the weight of each neuron.

According to an embodiment of the present disclosure, each neuron has n absolute values of the relative change with regards to n weights, and the average value Δ̅A̅ᵢ̅ of the n absolute values may be calculated for each neuron. Specifically, the average value Δ̅A̅ᵢ̅ may be expressed as follow

$$\overline{Δ {A}_{i}} = \frac{{\sum }_{i = 1}^{n} Δ {A}_{i}}{n} \qquad ( 2 )$$

Table 1 shows the average value Δ̅A̅ᵢ̅ of the absolute values of the relative change of the weights of 10 neurons in an embodiment of the present disclosure.

TABLE 1

| Neuron i | Δ̅A̅ᵢ̅/% |
|---|---|
| 1 | 10.74 |
| 2 | 5.08 |
| 3 | 6.41 |
| 4 | 4.74 |
| 5 | 21.12 |
| 6 | 44.60 |
| 7 | 3.15 |
| 8 | 38.93 |
| 9 | 62.71 |
| 10 | 2.87 |

According to an embodiment of the present disclosure, since different fluctuations of process parameters have different impact on current characteristics of transistors in different regions (subthreshold region, linear region, and saturation region), the influence caused by different neurons on the output is also different. The smaller the average value Δ̅A̅ᵢ̅ is, the smaller the weight variation range is, the higher the sensitivity of the neuron's weight to the output is, and the stronger the ability of the neuron in controlling the output of the artificial neural network system is. According to an embodiment of the present disclosure, the preliminary variational neurons can be obtained by selecting a fixed number of neurons with the smallest average values Δ̅A̅ᵢ̅. According to different embodiments, the average value of the absolute values of the relative change of the weights may be compared with a second threshold for example, neurons with average values smaller than the second threshold can be selected as a preliminary variational neuron.

At 124: Screening out the final variational neurons based on the output variation range of the preliminary variational neurons.

According to an embodiment of the present disclosure, the variation range of the output curve of the final variational neuron should be sufficiently large upon actual production requirements. For example, preliminary variational neurons whose output curve variation range is greater than or equal to a third threshold may be selected as the final variational neurons. According to an embodiment, the neuron output curve may be a normalized curve, and thus the third threshold may be 0.1 for example.

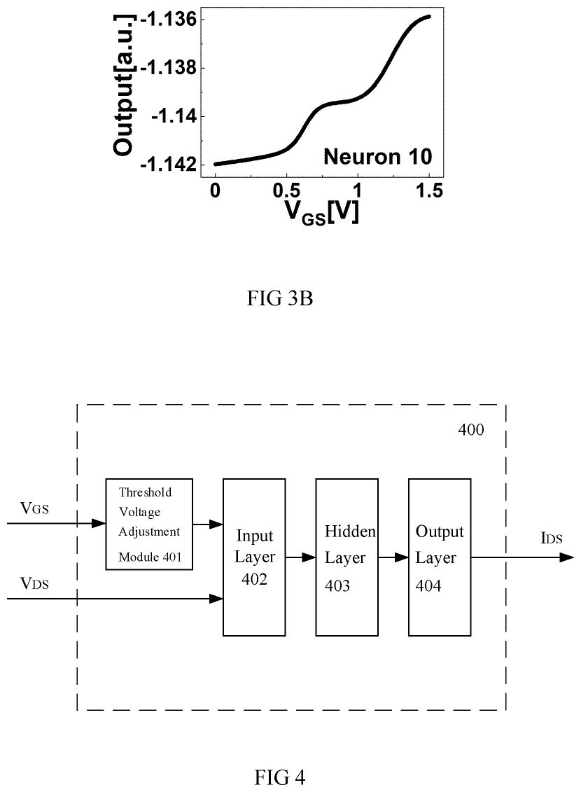

FIG. 3A-FIG. 3B are output curves of different preliminary variational neurons according to an embodiment of the present disclosure. According to Table 2, it can be seen that the control ability of neurons 2 and 10 is relatively strong. In addition, because, as shown in FIG. 3A, the variation range of the output curve of neuron 2 is about 1, which is more in line with the actual current output characteristic curve of the transistor, neuron 2 can be chosen as the final variational neuron. However, as shown in FIG. 3B, the variation range of the output curve of neuron 10 is about 0.04, thus neuron 10 shall not be selected as the final variational neuron, and neuron 10 will keep the initial weight in the nominal model when establishing the statistical model of transistors.

A method of calculating and obtaining the distribution of the weights of the final variational neurons and the distribution of the threshold voltages of the multiple transistors according to an embodiment of the present disclosure is introduced below.

According to different embodiments, the so-called variation here may refer to partial derivatives or changes reflected by other mathematical calculation methods. According to different embodiments, the so-called distribution here can be embodied as standard deviation, variance, or other forms.

Specifically, after the artificial neural network system completes the selection of final variational neurons, according to the distribution of transistor data in the first data set, such as the standard deviation of I_{DS} and V_{GS}, the distribution of the weights of final variational neurons in the transistor statistical model can be calculated, such as the standard deviation \hat{σ}_{W}_{ₘ}. According to an embodiment of the present disclosure, equation (3) can be used to calculate the distribution of the weights of the final variational neurons and the distribution of the threshold voltages:

$$[ \begin{matrix}{\hat{σ}}_{{I}_{DS \_ data} ( N )} \\ {\hat{σ}}_{{V}_{GS \_ data} ( N )} \\ {\hat{σ}}_{{I}_{DS \_ data} ( P )} \\ {\hat{σ}}_{{V}_{GS \_ data} ( P )}\end{matrix} ] = \qquad ( 3 )$$

$$[ \begin{matrix}\frac{\partial {I}_{DS} ( N )}{\partial {W}_{m} ( N )} & 0 & \frac{\partial {I}_{DS} ( N )}{\partial {V}_{th} ( N )} & 0 \\ … & … & … & … \\ \frac{\partial {V}_{GS} ( N )}{\partial {W}_{m} ( N )} & 0 & \frac{\partial {V}_{GS} ( N )}{\partial {V}_{th} ( N )} & 0 \\ 0 & \frac{\partial {I}_{DS} ( P )}{\partial {W}_{m} ( P )} & 0 & \frac{\partial {I}_{DS} ( P )}{\partial {V}_{th} ( P )} \\ … & … & … & … \\ 0 & \frac{\partial {V}_{GS} ( P )}{\partial {W}_{m} ( P )} & 0 & \frac{\partial {V}_{GS} ( P )}{\partial {V}_{th} ( P )}\end{matrix} ] \times [ \begin{matrix}{\hat{σ}}_{{W}_{m} ( N )} \\ {\hat{σ}}_{{W}_{m} ( P )} \\ {\hat{σ}}_{{V}_{th} ( N )} \\ {\hat{σ}}_{{V}_{th} ( P )}\end{matrix} ]$$

Since the transistors include P-type transistors and N-type transistors, the structures thereof are different, and the corresponding transistor parameters and calculation principles are also different. Therefore, when using the BPV (Backward Propagation of Variance) method for the calculation, separate calculations are required in terms of the P-type transistors and the N-type transistors.

According to an embodiment of the present disclosure, in equation (3),

$$[ \begin{matrix}{\hat{σ}}_{{I}_{DS \_ data} ( N )} \\ {\hat{σ}}_{{V}_{GS \_ data} ( N )} \\ {\hat{σ}}_{{I}_{DS \_ data} ( P )} \\ {\hat{σ}}_{{V}_{GS \_ data} ( P )}\end{matrix} ]$$

represent the distribution of drain-source current data I_{DS}_data and gate-source voltage data V_{GS_data} of multiple transistors,

$$[ \begin{matrix}\frac{\partial {I}_{DS} ( N )}{\partial {W}_{m} ( N )} & 0 & \frac{\partial {I}_{DS} ( N )}{\partial {V}_{th} ( N )} & 0 \\ … & … & … & … \\ \frac{\partial {V}_{GS} ( N )}{\partial {W}_{m} ( N )} & 0 & \frac{\partial {V}_{GS} ( N )}{\partial {V}_{th} ( N )} & 0 \\ 0 & \frac{\partial {I}_{DS} ( P )}{\partial {W}_{m} ( P )} & 0 & \frac{\partial {I}_{DS} ( P )}{\partial {V}_{th} ( P )} \\ … & … & … & … \\ 0 & \frac{\partial {V}_{GS} ( P )}{\partial {W}_{m} ( P )} & 0 & \frac{\partial {V}_{GS} ( P )}{\partial {V}_{th} ( P )}\end{matrix} ]$$

represent the variation of parameters in the nominal model with respect to weights of the final variational neurons and with respect to the threshold voltage (for example, the variation of the drain-source current I_{DS} in the nominal model with respect to the weight of each final variational neuron, the variation of the gate-source voltage V_{GS} in the nominal model with respect to the weight of each final variational neuron, the variation of the drain-source current I_{DS} with respect to the threshold voltages in the nominal model, and the variation of the gate-source voltage V_{GS} with respect to the threshold voltage in the nominal model), and

$$[ \begin{matrix}{\hat{σ}}_{{W}_{m} ( N )} \\ {\hat{σ}}_{{W}_{m} ( P )} \\ {\hat{σ}}_{{V}_{th} ( N )} \\ {\hat{σ}}_{{V}_{th} ( P )}\end{matrix} ]$$

represent the distribution of the weight of each final variational neuron and the distribution of the threshold voltage.

According to an embodiment of the present disclosure, the gate-source voltage V_{GS} and the gate-source voltage data V_{GS_data} in the first data set may be the gate-source voltage of the transistors in the subthreshold region.

According to an embodiment of the present disclosure, the variation of the gate-source voltage V_{GS} may be obtained by converting the nominal model from a model of outputting drain-source current to a model of outputting gate-source voltage, and calculating the variation of the model with respect to weights of the final variational neurons and with respect to the threshold voltage.

According to an embodiment, when the so-called variation here refers to partial derivative, it can be calculated by chain derivation method, or by numerical derivation and other methods to obtain partial derivative, which is determined upon actual needs.

According to an embodiment of the present disclosure, the data in the first data set may include one or more I_{DS} under different V_{DS} and V_{GS} biases, and one or more V_{GS} under different V_{DS} and I_{DS} biases, wherein part of the data is shown as Table 3.

TABLE 3

| Data | Description |
|---|---|
| I_{SAT} | I_{DS} at V_{DS} = 0.7 V and V_{GS} = 0.7 V |
| I_{LIN1} | I_{DS} at V_{DS} = 0.7 V and V_{GS} = 1.0 V |
| I_{LIN2} | I_{DS} at V_{DS} = 0.1 V and V_{GS} = 0.7 V |
| I_{LIN3} | I_{DS} at V_{DS} = 0.1 V and V_{GS} = 1.0 V |
| I_{SUB1} | I_{DS} at V_{DS} = 0.7 V and V_{GS} = 0.05 V |
| I_{SUB2} | I_{DS} at V_{DS} = 0.1 V and V_{GS} = 0.05 V |
| V_{GS1} | V_{GS} at I_{DS} = 10 nA and V_{DS} = 0.1 V |
| V_{GS2} | V_{GS} at I_{DS} = 10 nA and V_{DS} = 0.7 V |

In equation (3), \hat{σ}_{I}_{_{DS_data}}_{(N)} and \hat{σ}_{I}_{_{DS_data}}_{(P)} refer to the distribution of I_{DS} of N-type transistors and P-type transistors in the first data set. As shown in Table 3, I_{DS}_data may be one or more of I_{SAT} or I_{LIN} or I_{SUB}.

In equation (3), \hat{σ}_{V}_{_{GS_data}}_{(N)} and σ_{V}_{_{GS_data}}_{(P)} refer to the distribution of V_{GS} of N-type transistors and P-type transistors in the first data set. V_{GS_data} may be V_{GS1} and/or V_{GS2} in the V_{GS} shown in Table 3.

In equation (3), ∂I_{DS}/∂Wₘ represents the partial derivative of the I_{DS} in the nominal model with respect to the weight Wₘ of the final variational neuron m, where the I_{DS} can be one or more of the I_{DS} shown in Table 3, such as I_{SAT}. According to one embodiment, the final variational neuron m refers to the m^{th} neuron of all neurons in the system. When there are multiple final variational neurons, the partial derivative in equation (3) should be calculated with respect to the weight of each final variational neuron.

In equation (3), ∂I_{DS}/∂Vₜₕ represents the partial derivative of I_{DS} in the nominal model to the threshold voltage V^{th}, where I_{DS} can be one or more of I_{SAT} or I_{LIN} or I_{SUB} as shown in Table 3. In equation (3), ∂V_{GS}/∂Wₘ represents the partial derivative of V_{GS} in the nominal model with respect to the weight Wₘ of the final variational neuron m, where V_{GS} can be V_{GS1} and/or V_{GS2} in V_{GS} as shown in Table 3.

In equation (3), ∂V_{GS}/∂Vₜₕ represents the partial derivative of V_{GS} in the nominal model with respect to the threshold voltage V^{th}, where Vas can be V_{GS1} and/or V_{GS2} as shown in Table 3.

In equation (3), \hat{σ}_{W}_{ₘ}_{(N)} and σ_{W}_{ₘ}₍ₚ₎ are the standard deviations of weights of the final variational neurons; \hat{σ}_{V}_{ₜₕ}_{(N)} and \hat{σ}_{V}_{ₜₕ}₍ₚ₎ are the standard deviation of the threshold voltage. According to an embodiment of the present disclosure, other statistical methods may also be used to calculate the distribution of the threshold voltage and the distribution of weights of the final variational neurons.

The nominal model combined with the above calculation results can be used as the statistical model of multiple transistors of the same type based on the first data set.

FIG. 4 is a structure schematic diagram of an artificial neural network system for establishing a transistor statistical model according to an embodiment of the present disclosure.

According to an embodiment, the artificial neural network system 400 may include a threshold voltage adjustment module 401, configured to receive the gate-source voltage V_{GS} in the data set and the distribution σVₜₕ of the threshold voltage when applying the statistical model. The threshold voltage adjustment module 401 if configured to generate adjusted gate-source voltages V_{GS_Adjust}.

As shown in FIG. 4, the artificial neural network system 400 may further include an input layer 402, a hidden layer 403, and an output layer 404. The three layers may include multiple neurons that can transmit electrical signals.

According to an embodiment of the present disclosure, the artificial neural network system 400 may include one artificial neural network. Of course, the system can also have other structures, for example, including multiple artificial neural networks. Correspondingly, the artificial neural network system 400 may also include multiple hidden layers. The following description will be based on an example where the artificial neural network system 400 includes only one artificial neural network.

As shown in FIG. 4, in the process of applying the transistor statistical model of the present disclosure, the input layer 402 may be configured to receive the adjusted gate-source voltage V_{GS_Adjust} from the threshold voltage adjustment module and the drain-source voltage V_{DS} in a second data set. The input layer 402 may be coupled with the hidden layer 403, and the hidden layer 403 is coupled with the output layer 404, to transmit the electrical signals output by neurons to the output layer 404.

According to an embodiment, the second data set may include one or more sets of gate-source voltage and drain-source voltage data of multiple transistors of the same type.

According to an embodiment of the present disclosure, optionally, the artificial neural network system 400 may further include a normalization module (not shown), which may be coupled with the threshold voltage adjustment module 401 and the input layer 402. The normalization module performs normalizes the input data, and the data generated by the normalization will be converted into electrical signals and transmitted to the neurons in the input layer 402 for calculation. According to an embodiment of the present disclosure, the normalization module can also be configured to process the input data to satisfy the following relationship:

$${y}^{{′}^{( k )}} = log \frac{{y}^{( k )}}{{x}^{( k )}} \qquad ( 5 )$$

wherein y^{(k)} refers to the drain-source current I_{DS}^{(k)} of the k^{th} transistor, x^{(k)} refers to the drain-source voltage V_{DS}^{(k)} of the k^{th} transistor.

Optionally, the artificial neural network system 400 may further include a de-normalization module (not shown), which may be coupled with the output layer 404 of the artificial neural network. The denormalization module may de-normalize the calculation results output by the output layer 404 to obtain the drain-source current data obtained through the statistical model of the present disclosure.

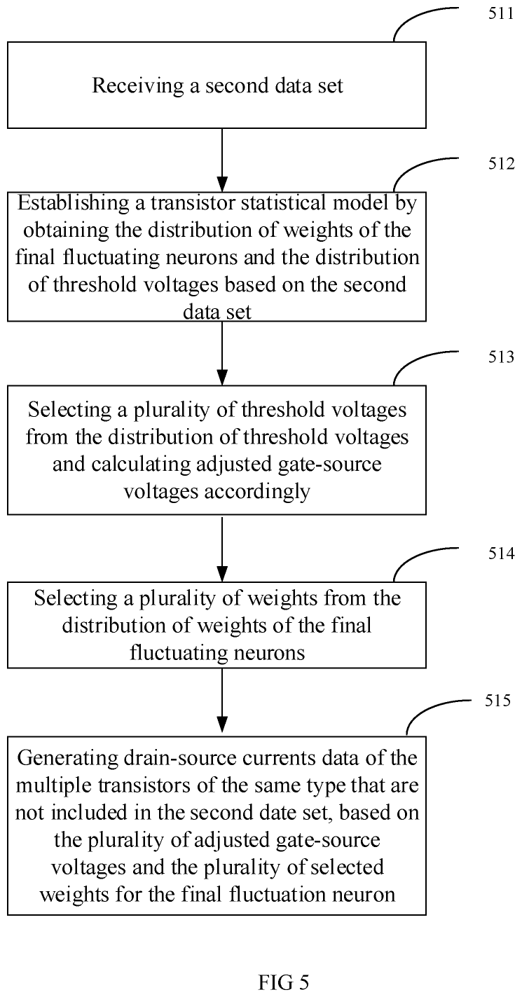

FIG. 5 is a flowchart of a method of applying a transistor statistical model based on an artificial neural network system according to an embodiment of the present disclosure.

As shown in FIG. 5, the method may include the following:

At 511: Receiving a second data set.

Taking the three-terminal transistor GAA-FET as an example, the second data set may include gate-source voltage data and drain-source voltage data of multiple transistors of the same type. According to an embodiment of the present disclosure, the plurality of transistors of the same type include a baseline transistor and a plurality of variational transistors, wherein the baseline transistor is determined according to a median or average value of the drain-source current data of the multiple transistors of the same type under the same bias condition, and the rest are called variational transistors. According to an embodiment of the present disclosure, the second data set also includes multiple sets of drain-source current data of the baseline transistor and part of the variational transistors.

At 512: Establishing a statistical model based on the data in the second data set, and obtaining the distribution of weights of the final variational neurons and the distribution of threshold voltages.

According to an embodiment of the present disclosure, the distribution of weights of the final variational neurons and the distribution of threshold voltages can be obtained with the above-described method of establishing a statistical model of transistors.

At 513: Selecting a plurality of threshold voltages from the distribution of threshold voltages and calculating adjusted gate-source voltages.

According to an embodiment of the present disclosure, when the second data set includes data of s transistors, the statistical model may generate transistor current models corresponding to data of q transistors (q may be an integer greater than 1 and less than or equal to s). Based on the threshold voltage Vₜₕ⁽⁰⁾ of the baseline transistor, q corresponding threshold voltages σVₜₕ are randomly selected according to the Gaussian distribution within the distribution of threshold voltages Vₜₕ^{(r)} in the model (r can be an integer greater than 1 and less than or equal to q), and the adjusted gate-source voltages V_{GS_Adjust} are calculated. Specifically, the adjusted gate-source voltages V_{GS_Adjust} satisfy the following relationship:

$${V}_{GS \_ Adjust} = {V}_{GS} + {V}_{th}^{( r )} - {V}_{th}^{( 0 )} \qquad ( 4 )$$

According to an embodiment of the present disclosure, Vₜₕ⁽⁰⁾ may be the corresponding threshold voltage when the drain-source current of a baseline transistor is 1 μA.

At 514: Selecting a plurality of weights in the distribution of weights of the final variational neurons.

According to an embodiment of the present disclosure, in the distribution ô_{W}_{ₘ} of weights of the final variational neurons, the weights Wₘ^{(r)} of each final variational neuron corresponding to the q transistors can be randomly selected according to the Gaussian distribution (r can be an integer greater than 1 and less than or equal to q).

At 515: Generating drain-source currents for the plurality of transistors based on the adjusted gate-source voltages, selected weights and corresponding drain-source voltage data.

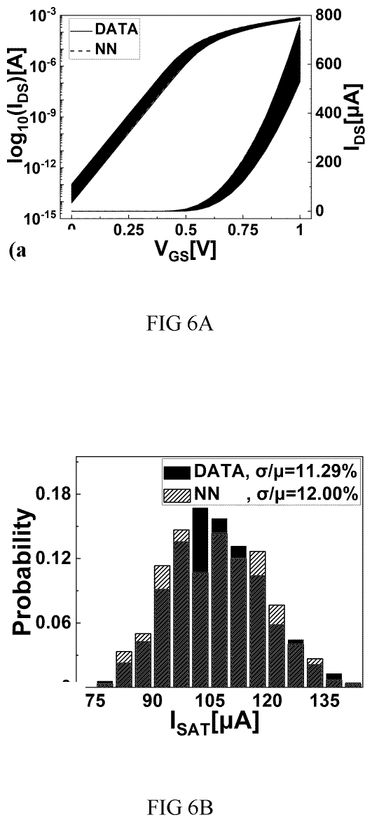

FIG. 6A shows a variation curve between drain-source current as an output versus gate-source voltage. The gray solid lines (looks like a gray area on the bottom due to the large number of lines) represent the drain-source current curves obtained by using the transistor model generated by the BSIM-CMG model based on physical mechanism, and the black dash lines (looks like a black area on top due to the large number of lines) represent the drain-source current curves obtained by using the transistor statistical model in the embodiment of the present disclosure. As shown in FIG. 6A, the two groups of curves basically overlap, which indicates that the transistor statistical model of the present disclosure meets expectations.

FIG. 6B is a probability distribution graph of I_{SAT} obtained by using a transistor statistical model of artificial neural network system of the present disclosure. The I_{SAT} in FIG. 6B is the drain-source current when the gate-source voltage V_{GS} and the drain-source voltage V_{DS} are both V_{DD}. The dark gray rectangles in FIG. 6B represent the data obtained by using the BSIM-CMG model based on physical mechanism, and the light gray striped rectangles represent the data obtained by using the statistical model of the present disclosure. As shown in FIG. 6B, the probability distribution error at each I_{SAT} index (the difference between the o/u values of the probability distribution curves generated by the two models) between the data of the transistor statistical model generated by the present disclosure and the test data does not exceed 1%. In practical applications, this error being less than 5% means that the statical model may have similar effect to that of the traditional model and has high precision.

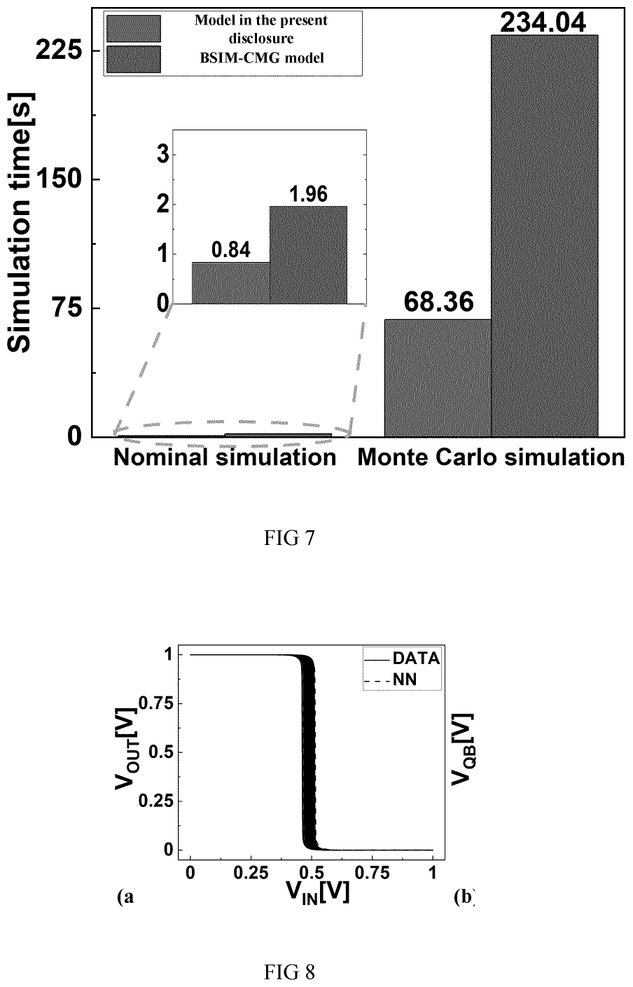

FIG. 7 is a comparison diagram of time consumption when performing simulation using a transistor statistical model of artificial neural network system of the present disclosure than using a traditional physical model. As shown in FIG. 7, the simulation is divided into single-nominal transistor simulation and multi-transistor Monte Carlo simulation. The light gray rectangles represent the time consumption by the artificial neural network statistical model of the present disclosure for simulation, and the dark gray rectangles represent the time consumption by the BSIM-CMG model based on physical mechanism for simulation. As shown in FIG. 7, the time consumption by the BSIM-CMG model is 3-4 times of the time consumption by the model of the present disclosure. Compared with the BSIM-CMG model, the simulation speed of the transistor statistical model based on the artificial neural network system of the present disclosure is greatly improved.

FIG. 8 is voltage transfer curves generated by applying the transistor statistical model to an inverter circuit according to an embodiment of the present disclosure, wherein the gray solid lines represent the test data generated by the BSIM-CMG model based on the physical mechanism, and the black dash lines represent the data generated by the transistor statistical model formed in the present disclosure. As shown in FIG. 8, the output characteristic curves of the transistor applied to the inverter circuit generated by the method of the present disclosure are basically consistent with the reference data, which has high precision and practicability.

The embodiment of the present disclosure also provides a simulation tool, which may include a transistor statistical model established based on artificial neural network system. The simulation tool can be embedded in simulation software such as SPICE to simulate a single transistor, multiple transistors of the same type, or an entire circuit module. During the simulation process, users may input gate-source voltage and the drain-source voltage data into the simulation tool to obtain simulation results such as drain-source current data of transistors of the same type.

The embodiment of the present disclosure also provides a computer-readable storage medium, for example, including a memory storing a computer program, which computer program can be executed to complete the steps of the method for establishing the transistor statistical model based on the artificial neural network system provided in any embodiment of the present disclosure. The computer storage medium can be such memory as FRAM, ROM, PROM, EPROM, EEPROM, Flash Memory, magnetic surface memory, optical disk, or CD ROM, etc.; it can also be various devices including one or any combination of the above-mentioned memories.

The embodiment of the present disclosure also provides a computer-readable storage medium, for example, including a memory storing a computer program, and the computer program can be executed to complete the steps of the method for applying the transistor statistical model of the artificial neural network system provided in any embodiment of the present disclosure. The computer storage medium can be such memory as FRAM, ROM, PROM, EPROM, EEPROM, Flash Memory, magnetic surface memory, optical disk, or CD ROM, etc.; it can also be various devices including one or any combination of the above-mentioned memories.

The solution of the present disclosure could, under the premises accelerating construction of transistor compact model, ensures low complexity and high precision of the model, and improves reliability of the model by grasping performance changes caused by process fluctuations, significantly increasing the simulation speed.

The foregoing embodiments are only for the purpose of illustrating the present disclosure, rather than limiting the same. Those skilled in the art can also make various changes and modifications without departing from the scope of the present disclosure. Therefore, all equivalent technical solutions should also fall into the scope disclosed in the present disclosure.

1. A method of establishing a transistor statistical model based on an artificial neural network system, comprising:
receiving a first data set, and generating a nominal model of a baseline transistor by the artificial neural network system based on the first data set, the first data set including multiple sets of gate-source voltage data, drain-source voltage data, and drain-source current data of multiple transistors of a same type, wherein the multiple transistors of a same type include the baseline transistor and a plurality of variational transistors, wherein the baseline transistor is determined according to a median or average value of the drain-source current data of the multiple transistors of the same type under the same bias condition, and the rest of the multiple transistors are variational transistors;
screening neurons in the artificial neural network system based on the first data set and the nominal model to obtain final variational neurons;
obtaining distribution of weights of the final variational neurons and distribution of threshold voltages based on variation of the nominal model with respect to weights of the final variational neurons, variation of the nominal model with respect to threshold voltage, distribution of the drain-source current and distribution of the gate-source voltage of the multiple transistors of the same type in the first data set; and
establishing the transistor statistical model based on the nominal model, the distribution of weights of the final variational neurons and the distribution of the threshold voltages.

2. The method according to claim 1, wherein said screening neurons in the artificial neural network system based on the first data set and the nominal model to obtain final variational neurons comprises,
changing weights of at least part of the neurons in the artificial neural network system in the nominal model, until difference between an intermediate output curve after the change of the weights and current-voltage characteristic curve of a variational transistor is less than a first threshold, and taking the changed weights as adjusted weights of the at least part of the neurons with regards to the variational transistor, wherein the intermediate output curve refers to the output curve obtained after change of the weights;
for each of the variational transistors, calculating an absolute value of relative change between the adjusted weights and initial weights for each of the at least part of the neurons in the nominal model;
calculating an average value of the absolute values for each of the at least part of the neurons in the artificial neural network system, and screening out preliminary variational neurons based on the average value; and
screening out the final variational neurons based on a range of output variation of the preliminary variational neurons.

3. (canceled)

4. (canceled)

5. The method according to claim 1, wherein,
the variation of the nominal model with respect to weights of the final variational neurons includes, a partial derivative of the drain-source current in the nominal model with respect to the weights of the final variational neurons and a partial derivative of the gate-source voltage in the nominal model with respect to the weights of the final variational neurons.

6. The method according to claim 1, wherein
the variation of the nominal model with respect to the threshold voltage includes, a partial derivative of the drain-source current in the nominal model with respect to the threshold voltage and a partial derivative of the gate-source voltage in the nominal model with respect to the threshold voltage.

7. The method according to claim 1, wherein
the distribution of the drain-source current and the distribution of the gate-source voltage of the multiple transistors of the same type in the first data set include a standard deviation of the drain-source current and a standard deviation of the gate-source voltage.

8. The method according to claim 1, wherein
the distribution of weights of the final variational neurons in the statistical model includes a standard deviation of weights of the final variational neurons, and the distribution of the threshold voltages in the statistical model includes a standard deviation of the threshold voltages.

9. A method of applying a transistor statistical model based on an artificial neural network system, comprising:
receiving a second data set including multiple sets of gate-source voltage data, drain-source voltage data of multiple transistors of a same type, the multiple transistors including a baseline transistor and a plurality of variational transistors, wherein the baseline transistor is determined according to a median or average value of drain-source current data of the multiple transistors of the same type under the same bias condition, and the rest are variational transistors, and the second data set also includes multiple sets of data of drain-source current data of the baseline transistors and part of the variational transistors;
establishing the transistor statistical model by obtaining distribution of threshold voltages in the statistical model and distribution of weights of final variational neurons based on the multiple sets of gate-source voltage data, drain-source voltage data and drain-source current data of the baseline transistor and part of variational transistors in the second data set, wherein the final variational neurons are from the artificial neural network system;
selecting a plurality of threshold voltages from the distribution of the threshold voltages, and calculating corresponding adjusted gate-source voltages accordingly to the selected threshold voltages;
selecting a plurality of weights for the final variational neurons from the distribution of weights of the final variational neurons; and
generating drain-source currents data of the multiple transistors of the same type that are not included in the second date set, based on the plurality of adjusted gate-source voltages and the plurality of selected weights for the final variational neuron.

10. The method according to claim 9, wherein
the threshold voltages are randomly selected based on Gaussian distribution from the distribution of the threshold voltages, and the corresponding weights are randomly selected based on Gaussian distribution from the distribution of weights of the final variational neurons.

11. The method according to claim 9, wherein establishing the statistical model by obtaining distribution of threshold voltages in the statistical model and distribution of weights of final variational neurons based on the multiple sets of gate-source voltage data, drain-source voltage data and drain-source current data of the baseline transistor and part of the variational transistors in the second data set comprises:
generating a nominal model of the baseline transistor by the artificial neutral network system based on the multiple sets of data of gate-source voltage data, drain-source voltage data, and drain-source current data of the baseline transistor and part of the variational transistors in the second data set;
screening neurons in the artificial neural network system to select final variational neurons based on the nominal model and the multiple sets of gate-source voltage data, drain-source voltage data and drain-source current data of the baseline transistor and part of the variational transistors in the second data set;
obtaining distribution of weights of the final variational neurons and distribution of threshold voltages in the statistical model based on variation of the nominal model with respect to weights of the final variational neurons, variation of the nominal model with respect to the threshold voltages, distribution of the drain-source current and distribution of the gate-source voltage of the baseline transistor and part of the variational transistors in the second data set; and
establishing the statistical model based on the nominal model, the distribution of weights of the final variational neurons and the distribution of the threshold voltages.

12. The method according to claim 11, wherein said screening neurons in the artificial neural network system to select final variational neurons based on the multiple sets of gate-source voltage data, drain-source voltage data and drain-source current data of the baseline transistors and part of the variational transistors in the second data set comprises:
changing weights of at least part of the neurons in the artificial neural network system in the nominal model, until difference between an intermediate output curve after the change of weights and a current-voltage characteristic curve of a variational transistor is less than a first threshold, taking the changed weights as adjusted weights of the at least part of the neurons with regards to the variational transistor, wherein the intermediate output curve refers to the output curve after change of the weights;
for each of the variational transistors, calculating absolute values of relative change between the adjusted weights and initial weights for each of the at least part of the neurons in the nominal model;
calculating an average value of the absolute values for each of the at least part of the neurons in the artificial neural network system, and screening out preliminary variational neurons according to the average values; and
screening out the final variational neurons based on neuron output variation range of the preliminary variational neurons.

13. (canceled)

14. (canceled)

15. The method according to claim 11, wherein
the variation of the nominal model with respect to weights of the final variational neurons includes, a partial derivative of the drain-source current in the nominal model with respect to the weights of the final variational neurons and a partial derivative of the gate-source voltage in the nominal model with respect to the weights of the final variational neurons.

16. The method according to claim 11, wherein
the variation of the nominal model with respect to the threshold voltage includes, a partial derivative of the drain-source current in the nominal model with respect to the threshold voltage and a partial derivative of the gate-source voltage in the nominal model with respect to the threshold voltage.

17. The method according to claim 11, wherein
the distribution of the drain-source current and the distribution of the gate-source voltage of the baseline transistor and part of variational transistors in the second data set include, a standard deviation of the drain-source current and a standard deviation of the gate-source voltage.

18. The method according to claim 11, wherein
the distribution of weights of the final variational neurons in the statistical model includes, standard deviation of weights of the final variational neurons, and the distribution of the threshold voltages in the statistical model includes, standard deviation of the threshold voltages.

19. (canceled)

20. A computer-readable storage medium, comprising a memory storing a computer program, the computer program being executed to complete the method of applying a transistor statistical model of an artificial neural network system, wherein the method comprises:
receiving a second data set including multiple sets of gate-source voltage data, drain-source voltage data of multiple transistors of a same type, the multiple transistors including a baseline transistor and a plurality of variational transistors, wherein the baseline transistor is determined according to a median or average value of drain-source current data of the multiple transistors of the same type under the same bias condition, and the rest are variational transistors, and the second data set also includes multiple sets of data of drain-source current data of the baseline transistors and part of the variational transistors;
establishing the transistor statistical model by obtaining distribution of threshold voltages in the statistical model and distribution of weights of final variational neurons based on the multiple sets of gate-source voltage data, drain-source voltage data and drain-source current data of the baseline transistor and part of variational transistors in the second data set, wherein the final variational neurons are from the artificial neural network system;
selecting a plurality of threshold voltages from the distribution of the threshold voltages, and calculating corresponding adjusted gate-source voltages accordingly to the selected threshold voltages;
selecting a plurality of weights for the final variational neurons from the distribution of weights of the final variational neurons; and
generating drain-source currents data of the multiple transistors of the same type that are not included in the second date set, based on the plurality of adjusted gate-source voltages and the plurality of selected weights for the final variational neuron.
